(19) United States
(12) Patent Application Publication
(10) Pub. No.: US 2025/0237742 A1
(43) Pub. Date: Jul. 24, 2025

(54) PERSONNEL DETECTION METHOD VIA MILLIMETER-WAVE RADARS, ELECTRONIC DEVICE AND COMPUTER READABLE STORAGE MEDIUM

(71) Applicant: Nanning FuLian FuGui Precision Industrial Co., Ltd., Nanning (CN)

(72) Inventors: CHIH-FENG HSIEH, New Taipei (TW); Guan-Yu Lin, Taipei City (TW); Ming Zeng, Nanning (CN)

(21) Appl. No.: 18/425,330

(22) Filed: Jan. 29, 2024

(30) Foreign Application Priority Data
Jan. 22, 2024 (CN) 202410090692.7

(51) Int. Cl. G01S 7/41; G01S 13/88

(52) U.S. Cl. CPC G01S 7/415; G01S 13/88

(57) ABSTRACT

A personnel detection method via millimeter-wave (mmWave) radars is disclosed. A mmWave radar is activated to emit radar waves to scan an indoor area. It is determined whether a bilateral head-shoulder difference of a human body is within a first angle, if so, it is determined whether a unilateral and bilateral head-shoulder difference of the human body is greater than the first angle and between a second angle and a third angle, and, if so, it is determined whether a reflection amount of a relative area of a head and shoulders is within a preset value. If the reflection amount is within the preset value, movement trajectories of a head and shoulder difference of the human body within the preset value is sampled. Thus, the number of people based on the sampled movement trajectories is determined.

### FIELD

The disclosure relates to millimeter-wave (mmWave) radars, and more particularly to a personnel detection method via millimeter-wave radars.

### BACKGROUND

In a conventional vital sign detecting device, the Doppler phase shift caused by a displacement of the body of a target organism can be directly eliminated by transmitting a single signal through two antennas to opposite sides of the target organism, thereby achieving vital sign detection. In this architecture, only one radar device is needed, and the vital sign detection can be performed with toleration for large displacement of the organism body without a high linearity requirement for the radar device.

In contrast, the existing technology for detecting respiratory and heart rate using radar are merely designed for close-range detection of a single target organism. Under this architecture, it is impossible to simultaneously detect the return signals of multi-target organisms at different distances.

An improved method generates signal strength versus distance data by analyzing received reflecting millimeter-wave signals, performs an extreme value reserving process to generate signal extreme value versus distance data, performs a peak search algorithm to obtain a peak list including a plurality of peak values and a plurality of corresponding peak distances, generates a distance array including a plurality of distance variables, and performs a vital sign detection algorithm to generate multiple sets of vital sign data.

However, simply using the peak values of the signal strength and judging the number of people based on the number of peak values cannot detect two individuals approaching each other in a static state.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a schematic diagram of an embodiment of a personnel detection method via millimeter-wave radars of the present disclosure;

FIG. 2 is a flowchart of an embodiment of a personnel detection method via millimeter-wave radars of the present disclosure;

FIG. 3 is a schematic diagram of an embodiment of determining bilateral head-shoulder differences of a human body of the present disclosure;

FIG. 4 is a schematic diagram of a first embodiment of determining unilateral and bilateral head and shoulders differences of the human body of the present disclosure;

FIG. 5 is a schematic diagram of a second embodiment of determining unilateral and bilateral head and shoulders differences of the human body of the present disclosure;

FIG. 6 is a schematic diagram of a first embodiment of determining a reflection amount of a relative area of the head and shoulders of the present disclosure;

FIG. 7 is a schematic diagram of a second embodiment of determining a relative area reflection amount of the head and shoulders of the present disclosure;

FIG. 8 is a block diagram of an embodiment of the hardware architecture of an electronic device using the method of the present disclosure; and

FIG. 9 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

An embodiment of a personnel detection method via millimeter-wave radars installs millimeter-wave (mmWave) radars on the ceiling to receive the height difference reflected waves generated by a head and shoulders of a human body and a relative area reflection amount of the head and shoulders of the human body. Therefore, people and the number of individuals can be identified in static or dark conditions.

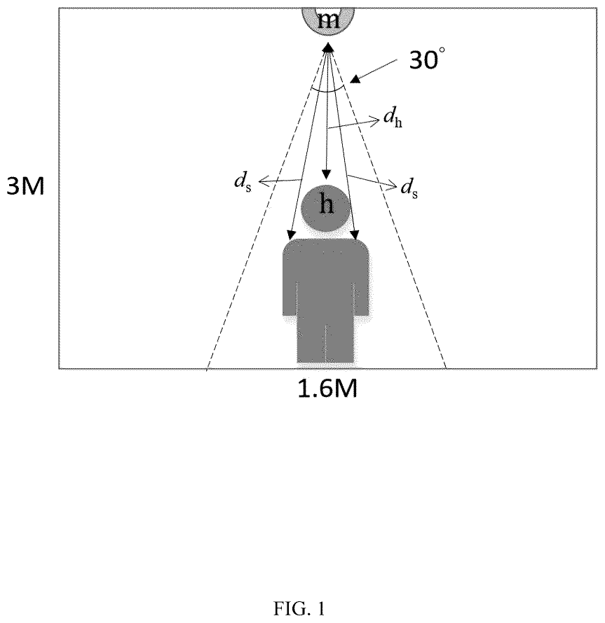

FIG. 1 is a schematic diagram of an embodiment of a personnel detection method via millimeter-wave radars of the present disclosure.

The embodiment of the personnel detection method via millimeter-wave radars vertically emits linear frequency modulated pulse signals, via a frequency modulated continuous wave (FMCW) radar system of a millimeter-wave radar, and captures reflected signals in the emission path. Distances between reflection points and the transmitting points can be calculated According to same-frequency reflected signals and a delay t of transmitted signals, d=(t×c)/2, where c indicates the light speed. After the above operation is repeated many times, a set of distances d₁, d₂, . . . , dᵢ can be obtained, where i represents the number of tests.

According to an indoor space of 3 meters high, a shoulder height of adults is 1.4 M˜1.5 M, and up to 2 people can stand within 30° of the radar wave angle. 1.6 M refers to a diameter of a circle that the radar can detect on the floor at an angle of 30 degrees. The reason for choosing 30° is that in a 3 M-high indoor space, the radar detects from the top of the head downwards, and it is easier to detect the two shoulders within 30°. However, the above perspectives are only examples and are not limited to this invention. Taking 15° is based on the fact that two people who can only stand side by side within the 30° range defined above divide 30 degrees equally, so each person occupies 15°. If it is greater than 30°, the two shoulders may not be detected.

The point h is defined as the head, the point m is defined as the mmWave radar, and a distance set dₕ=min(d₁, d₂, . . . , dᵢ) can define the distance between the head and the mmWave radar. It is determine whether there is a distance (dₕ+15 cm)<dₛ<(dₕ+30 cm) from the emission point within 30° around the point h. The distance dₕ (the distance between the head and the mmWave radar) is detected, and the distance dₛ (the distance between the shoulder and the mmWave radar) is further detected, thereby judging that the target is a human body.

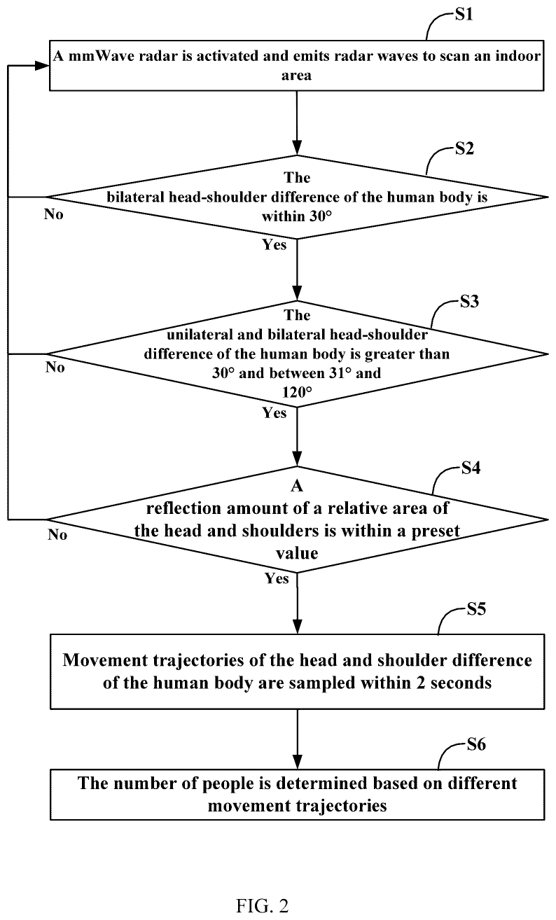

FIG. 2 is a flowchart of an embodiment of a personnel detection method via millimeter-wave radars of the present disclosure. According to different needs, the order of the steps in the flowchart can be changed, and some steps can be omitted.

In step S1, a mmWave radar is activated and emits radar waves to scan an indoor area.

In step S2, it is determined whether the bilateral head-shoulder difference of the human body is within 30°, and, if not, the process proceeds to step S1. The bilateral head-shoulder difference refers to the height difference between the head and the shoulders when the radar can detect both shoulders of a person. Similarly, the unilateral head-shoulder difference means the radar can only detect one shoulder of the person.

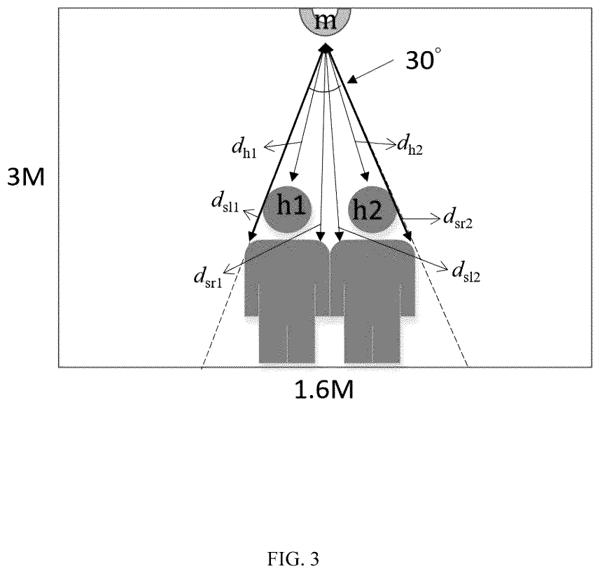

Referring to FIG. 3, according to an indoor space with a height of 3 meters (3 M), the shoulder height of an adult is 1.4 M˜1.5 M, and up to 2 people can stand within 30° of the radar wave angles. A distance set dₕ₁=min(d₁, d₂, . . . , dᵢ) is calculated to get h1 points, and a distance dₕ between the head and the mmWave radar is defined. A distance dₛ between the shoulder and the mmWave radar is calculated, where s represents a shoulder. It is determined whether there are emission points, (dₕ₁+15 cm)<dₛ<(dₕ₁+30 cm), distributed on both sides of the h1 points within an angle of 15° around the h1 points, and, if so, distances from the mmWave radar to the h1 points are defined as dₛₗ₁ and dₛᵣ₁ respectively, thereby determining that the h1 points and an area surrounding 15° of the h1 points are the human body.

Similarly, emission points based on dₕ₂=min(d₁, d₂, . . . , dᵢ) outside the 15° range of the h1 points are discovered. It is determined whether there are emission points, (dₕ₂+15 cm)<dₛ<(dₕ₂+30 cm), distributed on both sides of h2 points within an angle of 15° around the h2 points, and, if so, distances from the mmWave radar to the h2 points are defined as dₛₗ₂ and dₛᵣ₂ respectively, thereby determining that the h2 points and the area surrounding 15° of the h2 points are the human body.

In step S3, if the bilateral head-shoulder difference of the human body is within 30°, it is determined whether the unilateral and bilateral head-shoulder difference of the human body is greater than 30° and between 31° and 120°, and, if not, the process proceeds to step S1.

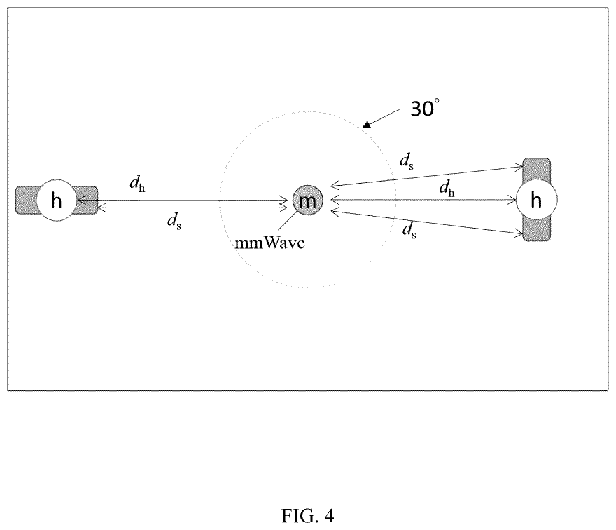

Referring to FIG. 4, if the unilateral and bilateral head-shoulder difference of the human body is greater than 30° and between 31° and 120° while one shoulder is blocked by the head which is difficult to judge, the position and height of the head is first determined and then the position of the shoulder in a straight-line distance is discovered for identification.

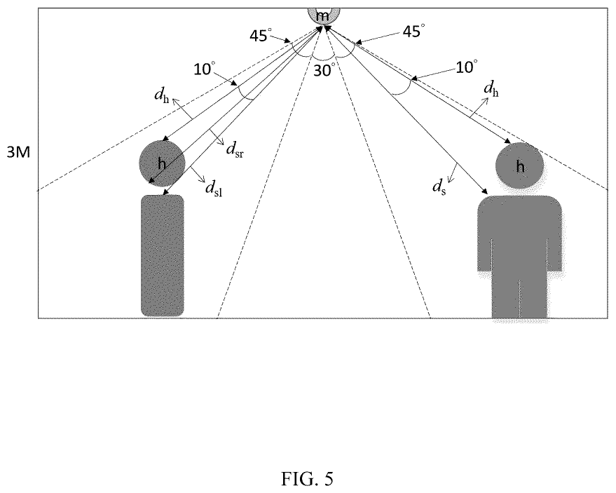

Referring to FIG. 5, A distance set dₕ=min(d₁, d₂, . . . ) is calculated to get the h points, and it is determined whether there are emission points, (dₕ+10 cm)<dₛ<(dₕ+20 cm), distributed on one side or both sides of the h points within an angle of 15° around the h points. If the emission points are distributed on both sides of the h points, they are defined as dₛₗ and dₛᵣ. If the emission points are distributed on one side of the h points, they are defined as dₛ. Thus, combinations of dₕ and both dₛₗ and dₛᵣ or dₕ and dₛ are determined as the human body.

It should be noted that (dₕ₂+15 cm)<dₛ<(dₕ₂+30 cm) means that within the radar detection range at a 30-degree angle, the height difference between a normal person's head and shoulders is approximately 15 cm to 30 cm, which is an estimated value. (dₕ+10 cm)<dₛ<(dₕ+20 cm) is because the detection angle shifts, and the corresponding head-shoulder distance will also become smaller. According to the angle calculation, it is about 10˜20 cm, which is also an estimate and is not limited to this.

In step S4, if the unilateral and bilateral head-shoulder difference of the human body is greater than 30° and is within 31° and 120°, it is determined whether a reflection amount of a relative area of the head and shoulders is within a preset value, and, if not, the process proceeds to step S1.

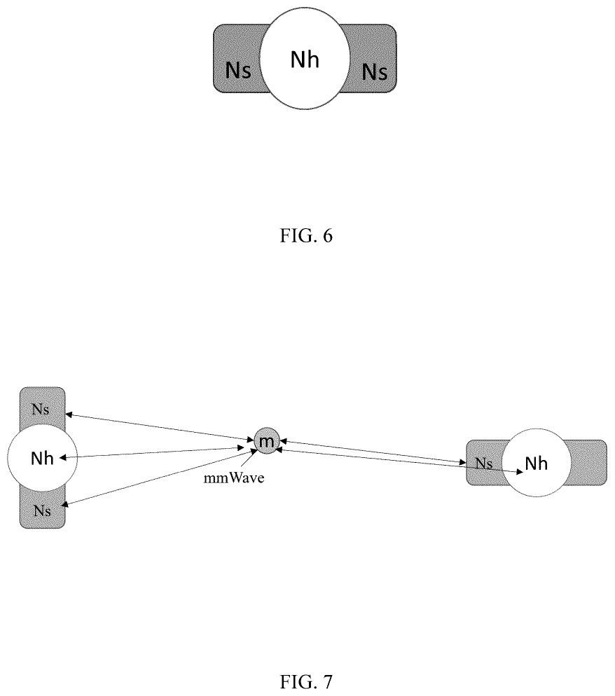

Referring to FIG. 6, when the number of people is determined by detecting the reflection amount of the relative area of the head and shoulders, as the angle around the radar wave is within 30°, the number of reflection points Nh at the relative head height and the number of reflection points Ns at the relative shoulder height must fall within a reasonable range of the relative area of the head and shoulders to avoid misjudging non-human objects, where the number of the reflection points on both sides refers to 1Nh+2Ns.

Referring to FIG. 7, when the number of people is determined by detecting the reflection amount of the relative area of the head and shoulders, as the angle around the radar wave is greater than 30° and within 30°, the number of reflection points Nh at the relative head height and the number of reflection points Ns at the relative shoulder height must fall within a reasonable range of the relative area of the head and shoulders to avoid misjudging non-human objects, where the number of the reflection points on one side refers to 1Nh+1Ns and the number of the reflection points on both sides refers to 1Nh+2Ns.

In step S5, if the reflection amount of the relative area of the head and shoulders is within the preset value, movement trajectories of the head and shoulder difference of the human body are sampled within 2 seconds. When people move, the movement trajectories of the head and shoulder difference of the human body is detected, and the movement trajectories within 2 seconds is sampled.

In step S6, the number of people is determined based on different movement trajectories.

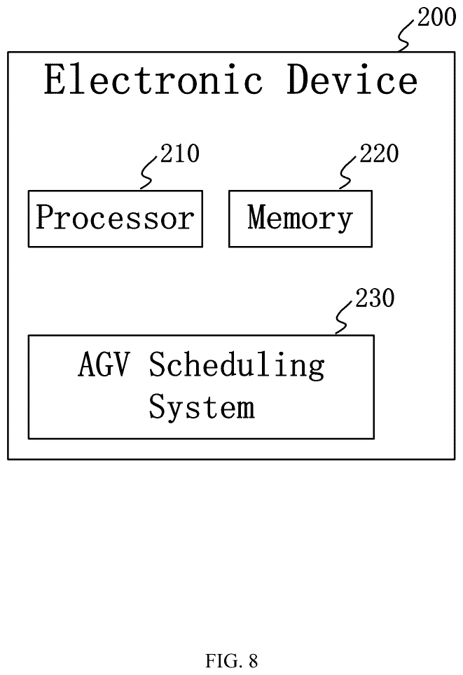

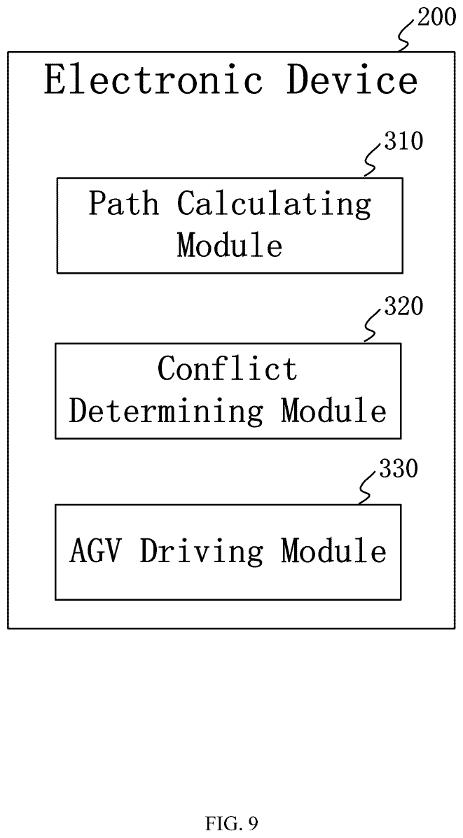

FIG. 8 is a block diagram of an embodiment of the hardware architecture of an electronic device using the personnel detection method via millimeter-wave radars of the present disclosure. The electronic device 200 may be, but is not limited to, connected to a processor 210, a memory 220, and a personnel detection system via millimeter-wave radars 230 via system buses. The electronic device 200 shown in FIG. 8 may include more or fewer components than those illustrated or may combine certain components.

The memory 220 stores a computer program, such as the personnel detection system via millimeter-wave radars 230, which is executable by the processor 210. When the processor 210 executes the personnel detection system via millimeter-wave radars 230, the blocks in one embodiment of the booting mode configuration method applied in the electronic device 200 are implemented, such as blocks S1 to S6 shown in FIG. 2.

It will be understood by those skilled in the art that FIG. 8 is merely an example of the electronic device 200 and does not constitute a limitation to the electronic device 200. The electronic device 200 may include more or fewer components than those illustrated, or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the personnel detection system via millimeter-wave radars 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The personnel detection system via millimeter-wave radars 230 can be partitioned into one or more modules/units that are stored in the memory 220 and executed by the processor 210. The one or more modules/units may be a series of computer program instructions capable of performing particular functions of the personnel detection system via millimeter-wave radars 230.

FIG. 7 is a schematic diagram of an embodiment of functional blocks of the electronic device using the method of the present disclosure.

The electronic device 200 comprises a mmWave radar emitting module 310, calculating and determining module 320 and trajectory sampling and personnel judging module 330.

The mmWave radar emitting module 310 activates a mmWave radar and emits radar waves to scan an indoor area.

The calculating and determining module 320 determines whether the bilateral head-shoulder difference of the human body is within 30°.

Referring to FIG. 3, according to an indoor space with a height of 3 meters (3 M), the shoulder height of an adult is 1.4 M˜1.5 M, and up to 2 people can stand within 30° of the radar wave angles. A distance set dₕ₁=min(d₁, d₂, . . . , dᵢ) is calculated to get h1 points, and a distance dₕ between the head and the mmWave radar is defined. A distance dₛ between the shoulder and the mmWave radar is calculated, where s represents a shoulder. It is determined whether there are emission points, (dₕ₁+15 cm)<dₛ<(dₕ₁+30 cm), distributed on both sides of the h1 points within an angle of 15° around the h1 points, and, if so, distances from the mmWave radar to the h1 points are defined as dₛₗ₁ and dₛᵣ₁ respectively, thereby determining that the h1 points and the area surrounding 15° of the h1 points are the human body.

Similarly, emission points based on dₕ₂=min(d₁, d₂, . . . , dᵢ) outside the 15° range of the h1 points are discovered. It is determined whether there are emission points, (dₕ₂+15 cm)<dₛ<(dₕ₂+30 cm), distributed on both sides of h2 points within an angle of 15° around the h2 points, and, if so, distances from the mmWave radar to the h2 points are defined as dₛₗ₂ and dₛᵣ₂ respectively, thereby determining that the h2 points and the area surrounding 15° of the h2 points are the human body.

The calculating and determining module 320, if the bilateral head-shoulder difference of the human body is within 30°, determines whether the unilateral and bilateral head-shoulder difference of the human body is greater than 30° and between 31° and 120°.

Referring to FIG. 4, if the unilateral and bilateral head-shoulder difference of the human body is greater than 30° and between 31° and 120° while one shoulder is blocked by the head which is difficult to judge, the position and height of the head is first determined and then the position of the shoulder in a straight-line distance is discovered for identification.

Referring to FIG. 5, A distance set dₕ=min(d₁, d₂, . . . ) is calculated to get the h points, and it is determined whether there are emission points, (dₕ+10 cm)<dₛ<(dₕ+20 cm), distributed on one side or both sides of the h points within an angle of 15° around the h points. If the emission points are distributed on both sides of the h points, they are defined as dₛₗ and dₛᵣ. If the emission points are distributed on one side of the h points, they are defined as dₛ. Thus, combinations of dₕ and both dₛₗ and dₛᵣ or dₕ and dₛ are determined as the human body.

The calculating and determining module 320, if the unilateral and bilateral head-shoulder difference of the human body is greater than 30° and is within 31° and 120°, determines whether a reflection amount of a relative area of the head and shoulders is within a preset value.

Referring to FIG. 6, when the number of people is determined by detecting the reflection amount of the relative area of the head and shoulders, as the angle around the radar wave is within 30°, the number of reflection points Nh at the relative head height and the number of reflection points Ns at the relative shoulder height must fall within a reasonable range of the relative area of the head and shoulders to avoid misjudging non-human objects, where the number of the reflection points on both sides refers to 1Nh+2Ns.

Referring to FIG. 7, when the number of people is determined by detecting the reflection amount of the relative area of the head and shoulders, as the angle around the radar wave is greater than 30° and within 30°, the number of reflection points Nh at the relative head height and the number of reflection points Ns at the relative shoulder height must fall within a reasonable range of the relative area of the head and shoulders to avoid misjudging non-human objects, where the number of the reflection points on one side refers to 1Nh+1Ns and the number of the reflection points on both sides refers to 1Nh+2Ns.

The personnel judging module 330 samples movement trajectories of the head and shoulder difference of the human body within 2 seconds. When people move, the movement trajectories of the head and shoulder difference of the human body is detected, and the movement trajectories within 2 seconds is sampled.

The personnel judging module 330 determines the number of people based on different movement trajectories.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A personnel detection method via millimeter-wave (mmWave) radars executable by an electronic device, comprising:
activating a mmWave radar to emit radar waves to scan an indoor area;
determining whether a bilateral head-shoulder difference of a human body is within a first angle;
if the bilateral head-shoulder difference of the human body is within the first angle, determining whether a unilateral and bilateral head-shoulder difference of the human body is greater than the first angle and between a second angle and a third angle;
if the unilateral and bilateral head-shoulder difference of the human body is greater than the first angle and between the second angle and the third angle, determining whether a reflection amount of a relative area of a head and shoulders is within a preset value;
if the reflection amount of the relative area of the head and shoulders is within the preset value, sampling movement trajectories of a head and shoulder difference of the human body within the preset value; and
determining the number of people based on the sampled movement trajectories.

2. The method of claim 1, wherein the step of determining whether the bilateral head-shoulder difference of the human body further comprises:
calculating a distance set dₕ₁=min(d₁, d₂, . . . , dᵢ) to get h1 points and defining a distance dₕ between the head and the mmWave radar, wherein h indicates the head, i indicates a testing frequency, and indicate a plurality of mmWave radar signals;
calculating a distance dₛ between the shoulder and the mmWave radar, where s indicates the shoulder;
determining whether there are emission points, (dₕ₁+(a first distance)<dₛ<dₕ₁+(a second distance)), distributed on both sides of the h1 points within a fourth angle around the h1 points; and
if there are emission points distributed on both sides of the h1 points within the fourth angle around the h1 points, defining distances from the mmWave radar to the h1 points as dₛₗ₁ and dₛᵣ₁ respectively, thereby determining that the h1 points and an area surrounding the fourth angle of the h1 points are the human body.

3. The method of claim 2, wherein the step of determining whether the bilateral head-shoulder difference of the human body further comprises:
discovering emission points based on dₕ₂=min(d₁, d₂, . . . , dᵢ) outside a range of the fourth angle of the h1 points;
determining whether there are emission points, (dₕ₂+(the first distance))<dₛ<(dₕ₂+(the second distance)), distributed on both sides of h2 points within the fourth angle around h2 points; and
if there are emission points distributed on both sides of the h2 points within the fourth angle around the h2 points, defining distances from the mmWave radar to the h2 points as dₛₗ₂ and dₛᵣ₂ respectively, thereby determining that the h2 points and an area surrounding the fourth angle of the h2 points are the human body.

4. The method of claim 3, wherein the first angle is 15°, the second angle is 31°, the third angle is 120°, the fourth angle is 15°, the first distance is 15 millimeters, and the second distance is 30 millimeters.

5. The method of claim 1, wherein the step of determining whether the unilateral and bilateral head-shoulder difference of the human body further comprises:
calculating a distance set dₕ=min(d₁, d₂, . . . ) to get h points;
determining whether there are emission points, (dₕ+(the first distance))<dₛ<(dₕ+(a third distance)), distributed on one side or both sides of the h points within a fifth angle around the h points;
if the emission points are distributed on both sides of the h points, defining the emission points as dₛₗ and dₛᵣ;
if the emission points are distributed on one sides of the h points, defining the emission points as dₛ; and
determining combinations of dₕ and both dₛₗ and dₛᵣ or dₕ and dₛ as the human body.

6. An electronic device, which includes a memory, a processor, and a serial number length adjustment program stored in the memory and operable on the processor, wherein the serial number length adjustment program is executed by the processor to implement following steps:
activating a mmWave radar to emit radar waves to scan an indoor area;
determining whether a bilateral head-shoulder difference of a human body is within a first angle;
if the bilateral head-shoulder difference of the human body is within the first angle, determining whether a unilateral and bilateral head-shoulder difference of the human body is greater than the first angle and between a second angle and a third angle;
if the unilateral and bilateral head-shoulder difference of the human body is greater than the first angle and between the second angle and the third angle, determining whether a reflection amount of a relative area of a head and shoulders is within a preset value;
if the reflection amount of the relative area of the head and shoulders is within the preset value, sampling movement trajectories of a head and shoulder difference of the human body within the preset value; and
determining the number of people based on the sampled movement trajectories.

7. The device of claim 6, wherein the processor further implements following steps:
calculating a distance set dₕ₁=min(d₁, d₂, . . . , dᵢ) to get h1 points and defining a distance dₕ between the head and the mmWave radar, wherein h indicates the head, i indicates a testing frequency, and indicate a plurality of mmWave radar signals;
calculating a distance dₛ between the shoulder and the mmWave radar, where s indicates the shoulder;
determining whether there are emission points, (dₕ₁+(a first distance))<dₛ<(dₕ₁+(a second distance)), distributed on both sides of the h1 points within a fourth angle around the h1 points; and
if there are emission points distributed on both sides of the h1 points within the fourth angle around the h1 points, defining distances from the mmWave radar to the h1 points as dₛₗ₁ and dₛᵣ₁ respectively, thereby determining that the h1 points and an area surrounding the fourth angle of the h1 points are the human body.

8. The device of claim 7, wherein the processor further implements following steps:
discovering emission points based on dₕ₂=min(d₁, d₂, . . . , dᵢ) outside a range of the fourth angle of the h1 points;
determining whether there are emission points, (dₕ₂+(the first distance))<dₛ<(dₕ₂+(the second distance)), distributed on both sides of h2 points within the fourth angle around h2 points; and
if there are emission points distributed on both sides of the h2 points within the fourth angle around the h2 points, defining distances from the mmWave radar to the h2 points as dₛₗ₂ and dₛᵣ₂ respectively, thereby determining that the h2 points and an area surrounding the fourth angle of the h2 points are the human body.

9. The device of claim 8, wherein the first angle is 15°, the second angle is 31°, the third angle is 120°, the fourth angle is 15°, the first distance is 15 millimeters, and the second distance is 30 millimeters.

10. The device of claim 6, wherein the processor further implements following steps:
calculating a distance set dₕ=min(d₁, d₂, . . . ) to get h points;
determining whether there are emission points, (dₕ+(the first distance))<dₛ<(dₕ+(a third distance)), distributed on one side or both sides of the h points within a fifth angle around the h points;
if the emission points are distributed on both sides of the h points, defining the emission points as dₛₗ and dₛᵣ;
if the emission points are distributed on one sides of the h points, defining the emission points as dₛ; and
determining combinations of dₕ and both dₛₗ and dₛᵣ or dₕ and dₛ as the human body.

11. A non-transitory computer-readable storage medium storing game program which causes a computer to execute:
a process of activating a mmWave radar to emit radar waves to scan an indoor area;
a process of determining whether a bilateral head-shoulder difference of a human body is within a first angle;
a process of, if the bilateral head-shoulder difference of the human body is within the first angle, determining whether a unilateral and bilateral head-shoulder difference of the human body is greater than the first angle and between a second angle and a third angle;
a process of, if the unilateral and bilateral head-shoulder difference of the human body is greater than the first angle and between the second angle and the third angle, determining whether a reflection amount of a relative area of a head and shoulders is within a preset value;
a process of, if the reflection amount of the relative area of the head and shoulders is within the preset value, sampling movement trajectories of a head and shoulder difference of the human body within the preset value; and
a process of determining the number of people based on the sampled movement trajectories.

12. The non-transitory computer-readable storage medium of claim 11, wherein the computer further executes:
a process of calculating a distance set dₕ₁=min(d₁, d₂, . . . , d₁) to get h1 points and defining a distance dₕ between the head and the mmWave radar, wherein h indicates the head, i indicates a testing frequency, and indicate a plurality of mmWave radar signals;
a process of calculating a distance dₛ between the shoulder and the mmWave radar, where s indicates the shoulder;
a process of determining whether there are emission points, (dₕ₁+(a first distance))<dₛ<(dₕ₁+(a second distance)), distributed on both sides of the h1 points within a fourth angle around the h1 points; and
a process of, if there are emission points distributed on both sides of the h1 points within the fourth angle around the h1 points, defining distances from the mmWave radar to the h1 points as dₛₗ₁ and dₛᵣ₁ respectively, thereby determining that the h1 points and an area surrounding the fourth angle of the h1 points are the human body.

13. The non-transitory computer-readable storage medium of claim 12, wherein the computer further executes:
a process of discovering emission points based on dₕ₂=min(d₁, d₂, . . . , dᵢ) outside a range of the fourth angle of the h1 points;
a process of determining whether there are emission points, (dₕ₂+(the first distance))<dₛ<(dₕ₂+(the second distance)), distributed on both sides of h2 points within the fourth angle around h2 points; and
a process of, if there are emission points distributed on both sides of the h2 points within the fourth angle around the h2 points, defining distances from the mmWave radar to the h2 points as dₛₗ₂ and dₛᵣ₂ respectively, thereby determining that the h2 points and an area surrounding the fourth angle of the h2 points are the human body.

14. The non-transitory computer-readable storage medium of claim 13, wherein the first angle is 15°, the second angle is 31°, the third angle is 120°, the fourth angle is 15°, the first distance is 15 millimeters, and the second distance is 30 millimeters.

15. The non-transitory computer-readable storage medium of claim 11, wherein the computer further executes:
a process of calculating a distance set dₕ=min(d₁, d₂, . . . ) to get h points;
a process of determining whether there are emission points, (dₕ+(the first distance))<dₛ<(dₕ+(a third distance)), distributed on one side or both sides of the h points within a fifth angle around the h points;
a process of, if the emission points are distributed on both sides of the h points, defining the emission points as dₛₗ and dₛᵣ;
a process of, if the emission points are distributed on one sides of the h points, defining the emission points as dₛ; and
a process of determining combinations of dₕ and both dₛₗ and dₛᵣ or dₕ and dₛ as the human body.
